(19) United States
(12) Patent Application Publication
(10) Pub. No.: US 2014/0018269 A1
(43) Pub. Date: Jan. 16, 2014

(54) POST-TREATED MOLYBDENUM IMIDE ADDITIVE COMPOSITION, METHODS OF MAKING SAME AND LUBRICATING OIL COMPOSITIONS CONTAINING SAME

(71) Applicants: Gaurav Bhalla, Hercules, CA (US); Kenneth Dale Nelson, Napa, CA (US); Man Hon Tsang, Richmond, CA (US)

(72) Inventors: Gaurav Bhalla, Hercules, CA (US); Kenneth Dale Nelson, Napa, CA (US); Man Hon Tsang, Richmond, CA (US)

(73) Assignee: Chevron Oronite Company LLC, San Ramon, CA (US)

(21) Appl. No.: 13/549,196

(22) Filed: Jul. 13, 2012

(51) Int. Cl. C10M 133/44; C07F 11/00

(52) U.S. Cl. CPC C10M 133/44; C07F 11/00
USPC 508/287; 548/404

(57) ABSTRACT

The invention is directed to an oil soluble additive composition prepared by a process comprising reacting a molybdenum component; an imide derived from the reaction product of a hydrocarbyl dicarboxylic acid component and a polyamine component wherein the hydrocarbyl dicarboxylic acid component is the reaction product of a dicarboxylic acid component and a hydrocarbyl component; and a post-treating agent, thereby producing a post-treated molybdated succinimide additive composition.

### FIELD OF THE INVENTION

This invention relates to new lubricating oil additives and lubricating oil compositions. More specifically, it relates to new lubricating oil compositions containing a friction reducing component comprising a molybdenum compound and alkyl or alkenyl imide.

### BACKGROUND OF THE INVENTION

Molybdenum disulfide has long been known as a desirable additive for use in lubricating oil compositions. Molybdenum disulfide is ordinarily finely ground and then dispersed in the lubricating oil composition to impart friction modifying and antiwear properties. However, one of the major detriments to using finely ground molybdenum disulfide is its lack of solubility.

As an alternative to using finely ground molybdenum disulfide as a friction modifier, a number of other approaches involving various salts of molybdenum compounds have been employed. Molybdenum dithiocarbamates (MoDTC) and molybdenum dithiophosphates (MoDTP) are well known in the art to impart friction modifying properties. Representative compositions of MoDTC are described in Larson et al., U.S. Pat. No. 3,419,589, which teaches molybdenum (VI) dioxide dialkyldithiocarbamates; Farmer et al., U.S. Pat. No. 3,509,051, which teaches sulfurized oxymolybdenum dithiocarbamates; and Sakurai et al., U.S. Pat. No. 4,098,705, which teaches sulfur containing molybdenum dihydrocarbyl dithiocarbamate compositions.

Representative compounds of MoDTP are the compositions described in Rowan et al., U.S. Pat. No. 3,494,866, such as oxymolybdenum diisopropylphosphorodithioate.

Another method of incorporating molybdenum compounds in oil is to prepare a colloidal complex of molybdenum disulfide or oxysulfides dispersed using known dispersants. Known dispersants include basic nitrogen containing compounds including succinimides, carboxylic acid amides, phosphonoamides, thiophosphonoamides, Mannich bases, and hydrocarbonpolyamines.

King et al., U.S. Pat. No. 4,263,152; King et al., U.S. Pat. No. 4,261,843; and King et al., U.S. Pat. No. 4,259,195 teach molybdenum compounds used as anti-oxidant and anti-wear additives comprising an acidic molybdenum compound and a basic nitrogen compound which acts as a dispersant.

DeVries et al., U.S. Pat. No. 4,259,194 discloses a sulfur containing additive comprising the reaction product of ammonium tetrathiomolybdate and a basic nitrogen compound for use as an anti-oxidant, anti-wear agent, and friction modifier.

Nemo, U.S. Pat. No. 4,705,643 teaches the preparation of carboxylic acid amides as detergent additives in lubricating oils.

Udding et al., U.S. Pat. No. 5,468,891 describes antifriction additives for lubricating oils comprising a molybdenum-containing complex prepared by reacting an alkaline earth metal salt of a carboxylic acid, an amine and a source of cationic molybdenum, wherein the ratio of the number of equivalents of acid groups to the number of moles of molybdenum (eq:mol) is in the range from 1:10 to 10:1, and the ratio of the number of equivalents of acid groups to the number of moles of amine (eq:mol) is in the range from 20:1 to 1:10.

Ruhe, Jr. et al., U.S. Pat. No. 6,962,896 describes antioxidant additives for lubricating oils comprising low color molybdenum compounds and polyamide dispersants including molybdenum oxysulfide polyamides.

Gatto et al., U.S. Pat. No. 6,174,842 discloses a lubricating oil composition comprising a lubricating oil, an oil-soluble molybdenum compound substantially free of reactive sulfur, an oil-soluble diarylamine and a calcium phenate as an anti-wear and anti-oxidant additive.

### SUMMARY OF THE INVENTION

An embodiment of the present invention is directed to an oil soluble additive composition prepared by a process comprising reacting, a molybdenum component; an imide derived from the reaction product of a hydrocarbyl dicarboxylic acid component and a polyamine component wherein the hydrocarbyl dicarboxylic acid component is the reaction product of a dicarboxylic acid component and a hydrocarbyl component; and a post-treating agent, thereby producing a post-treated molybdated succinimide additive composition.

An embodiment of the present invention is directed to a lubricating oil composition comprising (a) an oil of lubricating viscosity; and (b) the reaction product of (i) a molybdenum component; (ii) an imide derived from the reaction product of a hydrocarbyl dicarboxylic acid component and a polyamine component wherein the hydrocarbyl dicarboxylic acid component is the reaction product of a dicarboxylic acid component and a hydrocarbyl component; and (iii) a post-treating agent, thereby producing a post-treated molybdated succinimide additive composition.

An embodiment of the present invention is directed to a process for preparing an oil soluble additive composition which comprises reacting (a) a molybdenum component; (b) an imide derived from the reaction product of a hydrocarbyl dicarboxylic acid component and a polyamine component wherein the hydrocarbyl dicarboxylic acid component is the reaction product of a dicarboxylic acid component and a hydrocarbyl component; and (c) a post-treating agent, thereby producing a post-treated molybdated succinimide additive composition.

### DETAILED DESCRIPTION OF THE INVENTION

While the invention is susceptible to various modifications and alternative forms, specific embodiments thereof and are herein described in detail. It should be understood, however, that the description herein of specific embodiments is not intended to limit the invention to the particular forms disclosed, but on the contrary, the intention is to cover all modifications, equivalents, and alternatives falling within the spirit and scope of the invention as defined by the appended claims.

### DEFINITIONS

The following terms will be used throughout the specification and will have the following meanings unless otherwise indicated.

The term “polyamines” refers to organic compounds containing more than one basic nitrogen. The organic portion of the compound may contain aliphatic, cyclic, or aromatic carbon atoms.

The term “polyalkyleneamines” or “polyalkylenepolyamines” refers to compounds represented by the general formula

H₂N(—R—NH)ₙ—H

wherein R is an alkylene group of preferably 2-3 carbon atoms and n is an integer of from about 1 to 11.

The term “imide” refers to the reaction product of a dicarboxylic acid, carboxylate, anhydride of a dicarboxylic acid, or ester of a dicarboxylic acid and a polyamine.

The term “di-carboxylic acid component” refers to dicarboxylic acids, anhydrides of dicarboxylic acids, and esters of dicarboxylic acids that are capable of formation of imide reaction products with polyamines.

The term “molybdenum component” refers to reactive molybdenum compounds capable of forming a molybdenum: amine salt or molybdenum: amine complex.

The term “post-treating agent” refers to organic reagents capable of functionalizing amines.

The present invention is directed to an oil soluble additive composition that is useful in lubricating oils. The additive is prepared by reacting a molybdenum component and an alkyl or alkenyl succinimide component thereby producing a molybdated succinimide which is further reacted with a post-treating agent thereby producing a post-treated molybdated succinimide additive composition.

### Molybdenum Component

The molybdenum component used to prepare the oil soluble additive composition of the present invention is a molybdenum containing compound which may be a molybdenum oxide. The molybdenum component may also include molybdenum in any oxidation state. The molybdenum component useful in the preparation of the oil-soluble additive composition of the invention may be derived from molybdenum compounds including, but not limited to, molybdenum hexacarbonyl, molybdic acid, ammonium molybdate, ammonium dimolybdate, ammonium heptamolybdate, sodium molybdate, potassium molybdate, other alkali metal molybdates, alkaline earth metal molybdates, MoOCl₄, MoO₂Br₂, and Mo₂O₃Cl₆. Other molybdenum components include molybdenum trioxide and ammonium tetrathiomolybdate. Preferred molybdenum components are molybdenum trioxide and those components derived from molybdic acid and ammonium molybdate. A more preferred molybdenum component is molybdenum trioxide.

### Imide Component

The imides used in the preparation of the oil soluble additive composition of the present invention are the reaction product of a hydrocarbyl dicarboxylic acid component and a polyamine component. The hydrocarbyl dicarboxylic acid component is the reaction product of a dicarboxylic acid component and a hydrocarbyl component.

The dicarboxylic acid components are substituted (i.e., hydrocarbyl) succinic acylating agents, preferably dicarboxylic acids or anhydrides of the dicarboxylic acid components, more preferably anhydrides of succinic acid components.

The hydrocarbyl component may have a molecular of up to 5000 molecular weight. Preferably, the molecular weight of the hydrocarbyl component is from about 110 to about 5000. More preferred, the molecular weight of the hydrocarbyl component is from about 110 to 2300. Most preferred, the molecular weight of the hydrocarbyl component is from about 110 to about 1300. In one embodiment, the molecular weight of the hydrocarbyl component is from about 180 to about 5000. More preferred, the molecular weight of the hydrocarbyl component is from about 200 to about 5000. The hydrocarbyl component generally contains an average number of carbon atoms from about 8 to about 400, preferably from about 12 to about 93, more preferably from about 16 to about 72.

Preferably, the hydrocarbyl component is an alkyl group or an alkenyl group. The alkenyl group may be derived from one or more of the olefins.

Examples of the olefins are derived from polymers of ethylene, propylene, butylene and iso-butylene include butene, isobutene, 1-octene, octene, 1-nonene, 1-decene, 1-dodecene, 1-tridecene, 1-tetradecene, 1-pentadecene, 1-hexadecene, 1-heptadecene, 1 octadecene, 1-nonadecene, 1-eicosene, 1-henicosene, 1-docosene, 1-tetracosene, etc. Commercially available alpha-olefin fractions that can be used include the C₁₅₋₁₈ alpha-olefins, C₁₂₋₁₆ alpha-olefins, C₁₄₋₁₆ alpha-olefins, C₁₄₋₁₈ alpha-olefins, C₁₆₋₁₈ alpha-olefins, C₁₆₋₂₀ alpha-olefins, C₂₂₋₂₈ alpha-olefins, etc. The C₁₆ and C₁₆₋₁₈ alpha-olefins and polyisobutene are particularly preferred.

The succinic acylating agents are prepared by reacting the above-described olefins or isomerized olefins with unsaturated dicarboxylic acids such as fumaric acids or maleic acid or anhydrides of the dicarboxylic acids at a temperature of about 160° C. to about 240° C., preferably about 185° C. to about 210° C. Free radical inhibitors (e.g., t-butyl catechol) may be used to reduce or prevent the formation of polymeric byproducts. The procedures for preparing the acylating agents are well known to those skilled in the art and have been described for example in U.S. Pat. No. 3,412,111; and Ben et al, “The Ene Reaction of Maleic Anhydride With Alkenes”, J. C. S. Perkin II (1977), pages 535-537. These references are incorporated by reference for their disclosure of procedures for making the above acylating agents.

The hydrocarbyl-substituted succinic acylating agents are available commercially and may be purchased from Dixie Chemical Company, Inc., Pasadena, Tex. or from Chevron Oronite Company LLC, Houston, Tex.

In the reaction of the hydrocarbyl dicarboxylic acid component and the amine component to form an imide, the charge mole ratio of the hydrocarbyl carboxylic acid component to amine component is about 1:1 to 1:0.5. Preferably from about 1:1 to 1:0.7. More preferred about 1:0:9.

In one embodiment, the imide is derived from 1) an aliphatic dicarboxylic acid component having from about 4 and 400 carbons and 2) a polyamine component having from about 2 and 10 nitrogen atoms. In a preferred embodiment the dicarboxylic acid component is a hydrocarbyl, such as hexadecenyl, succinic anhydride and the polyamine component is selected from the group consisting of tetraethylenepentamine, diethylenetriamine, ethylenediamine, and mixtures thereof. In a preferred embodiment the hydrocarbyl dicarboxylic acid component is polyisobutenyl succinic anhydride (PIBSA) and the polyamine component is selected from the group consisting of tetraethylenepentamine, diethylenetriamine, ethylenediamine and mixtures thereof.

The hydrocarbyl dicarboxylic acid component and polyamine component described herein below can be reacted to form imides prior to or during reaction with the molybdenum component. Imide compositions useful in the invention include those disclosed in U.S. Pat. Nos. 8,076,275; 6,962,896; 6,156,850 and 5,821,205 and the like, the disclosures of which is hereby incorporated by reference. These compositions are ordinarily prepared by reacting a dicarboxylic acid, dicarboxylic acid salt, dicarboxylic acid anhydride, or dicarboxylic acid ester having at least 4 to about 400 carbon atoms and, if desired, having pendant aliphatic groups to render the molecule oil soluble, with a polyamine, such as an ethylene diamine, to give an imide. Preferred are those imides prepared from (1) an aliphatic dicarboxylic anhydride, such as maleic anhydride and (2) an ethylene polyamine, such as tetraethylenepentamine, diethylenetriamine, ethylene diamine or mixtures thereof. Preferably, the imides useful in this invention will have at least one basic nitrogen.

### Polyamine Component

The polyamine component used in the preparation of the oil soluble additive composition of the present invention includes aromatic, cyclic, and aliphatic (linear and branched) polyamines and mixtures thereof. Examples of aromatic polyamines include, but are not limited to, phenylenediamine, 2,2′-diaminodiphenylmethane, 2,4- and 2,6-diaminotoluene, 2,6-diamino-p-xylene, multi-nuclear and condensed aromatic polyamines such as naphthylene-1,4-diamine, benzidine, 2,2′-dichloro-4,4′-diphenyl diamine and 4,4′-diaminoazobenzene. In another embodiment the polyamine component comprises polyamines of from about 5 to 32 ring members and having from about 2 to 8 amine nitrogen atoms. Such polyamine compounds include such compounds as piperazine, 2-methylpiperazine, N-(2-aminoethyl)piperazine, N-(2-hydroxyethyl)piperazine, 1,2-bis-(N-piperazinyl)ethane, 3-aminopyrrolidine, N-(2-aminoethyl)pyrrolidine, and aza crown compounds such as triazacyclononane, tetraazacyclododecane, and the like.

In a preferred embodiment, the polyamine component used in the preparation of this invention are polyalkylenepolyamines and can be represented by the general formula

H₂N(—R—NH)ₙ—H

wherein R is an alkylene group of preferably 2-3 carbon atoms and n is an integer of from 1 to 11.

Specific examples of polyalkylenepolyamines include, but are not limited to, diethylenetriamine, triethylenetetramine, tetraethylenepentamine, pentaethylenehexamine, hexaethyleneheptamine, heptaethyleneoctamine, octaethylenenonamine, nonaethylenedecamine, decaethyleneundecamine, undecaethylenedodecamine, dipropylenetriamine, tripropylenetetramine, tetrapropylenepentamine, pentapropylenehexamine, hexapropyleneheptamine, heptapropyleneoctamine, octapropylenenonamine, nonapropylenedecamine, decapropyleneundecamine, undecapropylenedodecamine, di(trimethylene)triamine, tri(trimethylene)tetramine, tetra(trimethylene)pentamine, penta(triethylene)hexamine, hexa(trimethylene)heptamine, hepta(trimethylene)octamine, octa(trimethylene)nonamine, nona(trimethylene)decamine, deca(trimethylene)undecamine and undeca(trimethylene)dodecamine.

### Post-Treating Agent

In one embodiment, a post-treating agent is employed to post-treat the product of the reaction of the molybdenum component and the hydrocarbyl succinimide Typical post-treating agents are cyclic carbonates and epoxides. Examples of post-treating agents are disclosed in Wollenberg et al., U.S. Pat. No. 4,612,132, Wollenberg et al., U.S. Pat. No. 4,746,446; Wollenberg et al., U.S. Pat. No. 4,713,188 and the like as well as other post-treatment processes each of which are incorporated herein by reference in its entirety. Examples of other post-treating agents are disclosed in LeSeur et al., U.S. Pat. No. 3,373,111 and Efner, U.S. Pat. No. 4,737,160 and the like as well other post-treatment processes each of which are incorporated herein by reference in its entirety. In one embodiment, the post-treating agent may be ethylene carbonate or glycerine carbonate.

### Method for Making the Oil Soluble Composition of the Present Invention

The preparation of this invention may be carried out by reacting carboxylic acid component, such as alkenyl succinic anhydride, with polyamine component under reaction conditions thereby producing an imide, such as a succinimide. A polar promoter can be optionally added to the reaction mixture. A post-treating agent is then added to the reaction mixture after the reaction mixture has heated up to 165° C. thereby resulting in a post-treated succinimide. The post-treated succinimide is then reacted with a source of molybdenum, thereby resulting in a molybdated post-treated succinimide.

In one embodiment, a carboxylic acid component, such as alkenyl succinic anhydride, with polyamine component under reaction conditions thereby producing an imide, such as a succinimide. A polar promoter can be optionally added to the reaction mixture. A source of molybdenum is reacted with the imide to form a molybdated succnimide. The molybdated succinimide is then reacted with a post-treating agent after the mixture has been heated to 165° C., thereby resulting in a molybdated pos-treated succinimide.

The reaction is ordinarily carried out at atmospheric pressure; however, higher or lower pressures may be used, if desired, using methods that are well-known to those skilled in the art. A diluent may be used to enable the reaction mixture to be efficiently stirred. Typical diluents are lubricating oil and liquid compounds containing only carbon and hydrogen. If the mixture is sufficiently fluid to permit satisfactory mixing, no diluent is necessary. A diluent which does not react with the molybdenum component is desirable.

As mentioned hereinabove, optionally, a polar promoter may be employed in the preparation of the present invention. The polar promoter facilitates the interaction between the molybdenum component and the basic nitrogen of the polyamine or amide component. A wide variety of such promoters may be used. Typical promoters are 1,3-propanediol, 1,4-butanediol, diethylene glycol, butyl cellosolve, propylene glycol, 1,4-butyleneglycol, methyl carbitol, ethanolamine, diethanolamine, N-methyl-diethanol-amine, dimethyl formamide, N-methyl acetamide, dimethyl acetamide, ammonium hydroxides, tetra-alkyl ammonium hydroxides, alkali metal hydroxides, methanol, ethylene glycol, dimethyl sulfoxide, hexamethyl phosphoramide, tetrahydrofuran, acetic acid, inorganic acids, and water. Preferred are water and ethylene glycol. Particularly preferred is water.

While ordinarily the polar promoter is separately added to the reaction mixture, it may also be present, particularly in the case of water, as a component of non-anhydrous starting materials or as waters of hydration in the molybdenum component, such as (NH₄)₆Mo₇O₂₄.4H₂O. Water may also be added as ammonium hydroxide.

A general method for preparing the oil soluble additive compositions of this invention comprises reacting (1) a molybdenum component and (2) an imide of a carboxylic acid and a polyamine in which the carboxylic acid and polyamine have a charge mole ratio (CMR) of between about 1:1 to about 1:05. Optionally, (3) a polar promoter or (4) a diluent, to form a salt or (5) both a polar promoter and a diluent may be added. The diluent is used, if necessary, to provide a suitable viscosity to facilitate mixing and handling. Typical diluents are lubricating oil and liquid compounds containing only carbon and hydrogen. Optionally, ammonium hydroxide may also be added to the reaction mixture to provide a solution of ammonium molybdate. The molybdenum component, imide, polar promoter, if used, and diluent, if used, are charged to a reactor and heated at a temperature less than or equal to about 200° C., preferably from about 70° C. to about 120° C. The temperature is maintained at a temperature less than or equal to about 200° C., preferably at about 70° C. to about 90° C., until the molybdenum component is sufficiently reacted. The reaction time for this step is typically in the range of from about 1 to about 30 hours and preferably from about 1 to about 10 hours.

Typically excess water and any volatile diluents are removed from the reaction mixture. Removal methods include, but are not limited to, vacuum distillation or nitrogen stripping while maintaining the temperature of the reactor at a temperature less than or equal to about 200° C., preferably between about 70° C. to about 90° C. The removal of water and volatile diluents is ordinarily carried out under reduced pressure. The pressure may be reduced incrementally to avoid problems with foaming After the desired pressure is reached, the stripping step is typically carried out for a period of about 0.5 to about 5 hours and preferably from about 0.5 to about 2 hours.

In the reaction mixture the ratio of molybdenum atoms to basic nitrogen atoms provided by the imide can range from about 0.01 to 4.0 atoms of molybdenum per basic nitrogen atom. Usually the reaction mixture is charged from 0.01 to 2.00 atoms of molybdenum per basic nitrogen atom provided by the amide. Preferably from 0.4 to 1.0, and more preferably from 0.4 to 0.7, atoms of molybdenum per atom of basic nitrogen are added to the reaction mixture.

The polar promoter, which is preferably water, is ordinarily present in the ratio of 0.1 to 50 moles of water per mol of molybdenum. Preferably from 0.5 to 25 and most preferably 1.0 to 15 moles of the promoter is present per mole of molybdenum.

The charge mole ratio of the carboxylic acid component to polyamine is critical and can range from 1:1 to 1:0.5. More preferred, from about 1:1 to about 1:07. Most preferred, the charge mole ratio of the carboxylic acid is 1:0.9. The imide formed from the reaction of the di-carboxylic acid component and the polyamine may occur prior to, during, or after the introduction of the molybdenum component to the reaction mixture.

The reaction mixture (i.e., the reaction of the molybdenum component, the imide component and the optional steps described hereinabove) is further reacted with a post-treating agent such as, but not limited to, ethylene carbonate and glycerine carbonate.

### Additive Concentrates

In many instances, it may be advantageous to form concentrates of the oil soluble additive composition of the present invention within a carrier liquid. These additive concentrates provide a convenient method of handling, transporting, and ultimately blending into lubricant base oils to provide a finished lubricant. Generally, the oil soluble additive concentrates of the invention are not useable or suitable as finished lubricants on their own. Rather, the oil soluble additive concentrates are blended with lubricant base oil stocks to provide a finished lubricant. It is desired that the carrier liquid readily solubilizes the oil soluble additive of the invention and provides an oil additive concentrate that is readily soluble in the lubricant base oil stocks. In addition, it is desired that the carrier liquid not introduce any undesirable characteristics, including, for example, high volatility, high viscosity, and impurities such as heteroatoms, to the lubricant base oil stocks and thus, ultimately to the finished lubricant. The present invention therefore further provides an oil soluble additive concentrate composition comprising an inert carrier fluid and from 2.0% to 90% by weight, based on the total concentrate, of an oil soluble additive composition according to the invention. The inert carrier fluid may be a lubricating oil.

These concentrates usually contain from about 2.0% to about 90% by weight, preferably 10% to 50% by weight of the oil soluble additive composition of this invention and may contain, in addition, one or more other additives known in the art and described below. The remainder of the concentrate is the substantially inert carrier liquid.

### Lubricating Oil Compositions

In one embodiment of the invention, the oil soluble additive composition of the present invention can be mixed with a base oil of lubricating viscosity to form a lubricating oil composition. The lubricating oil composition comprises a major amount of a base oil of lubricating viscosity and a minor amount of the oil soluble additive composition of the present invention described above.

The lubricating oil which may be used in this invention includes a wide variety of hydrocarbon oils, such as naphthenic bases, paraffin bases and mixed base oils as well as synthetic oils such as esters and the like. The lubricating oils which may be used in this invention also include oils from biomass such as plant and animal derived oils. The lubricating oils may be used individually or in combination and generally have viscosity which ranges from 7 to 3,300 cSt and usually from 20 to 2000 cSt at 40° C. Thus, the base oil can be a refined paraffin type base oil, a refined naphthenic base oil, or a synthetic hydrocarbon or non-hydrocarbon oil of lubricating viscosity. The base oil can also be a mixture of mineral and synthetic oils. Mineral oils for use as the base oil in this invention include, for example, paraffinic, naphthenic and other oils that are ordinarily used in lubricating oil compositions. Synthetic oils include, for example, both hydrocarbon synthetic oils and synthetic esters and mixtures thereof having the desired viscosity. Hydrocarbon synthetic oils may include, for example, oils prepared from the polymerization of ethylene, i.e., polyalphaolefin or PAO, or from hydrocarbon synthesis procedures using carbon monoxide and hydrogen gases such as in a Fisher-Tropsch process. Useful synthetic hydrocarbon oils include liquid polymers of alpha olefins having the proper viscosity. Likewise, alkyl benzenes of proper viscosity, such as didodecyl benzene, can be used. Useful synthetic esters include the esters of monocarboxylic acids and polycarboxylic acids, as well as mono-hydroxy alkanols and polyols. Typical examples are didodecyl adipate, pentaerythritol tetracaproate, di-2-ethylhexyl adipate, dilaurylsebacate, and the like. Complex esters prepared from mixtures of mono and dicarboxylic acids and mono and dihydroxy alkanols can also be used. Blends of mineral oils with synthetic oils are also useful.

The lubricating oil compositions containing the oil soluble additives of this invention can be prepared by admixing, by conventional techniques, the appropriate amount of the oil soluble additives of the invention with a lubricating oil. The selection of the particular base oil depends on the contemplated application of the lubricant and the presence of other additives. Generally, the amount of the oil soluble additive of the invention in the lubricating oil composition of the invention will vary from 0.05 to 15% by weight and preferably from 0.2 to 1% by weight, based on the total weight of the lubricating oil composition. In one embodiment, the molybdenum content of the lubricating oil composition will be between about 50 parts per million (ppm) and 5000 ppm, preferably between about 90 ppm to 1500 ppm. In another embodiment the molybdenum content of the lubricating oil composition will be between about 500 ppm and 700 ppm.

### Additional Additives

If desired, other additives may be included in the lubricating oil and lubricating oil concentrate compositions of this invention. These additives include antioxidants or oxidation inhibitors, dispersants, rust inhibitors, anticorrosion agents and so forth. Also, anti-foam agents, stabilizers, anti-stain agents, tackiness agents, anti-chatter agents, dropping point improvers, anti-squawk agents, extreme pressure agents, odor control agents and the like may be included.

The following additive components are examples of some of the components that can be favorably employed in the lubricating oil compositions of the present invention. These examples of additional additives are provided to illustrate the present invention, but they are not intended to limit it:

### Metal Detergents

Detergents which may be employed in the present invention include alkyl or alkenyl aromatic sulfonates, calcium phenate, borated sulfonates, sulfurized or unsulfurized metal salts of multi-hydroxy alkyl or alkenyl aromatic compounds, alkyl or alkenyl hydroxy aromatic sulfonates, sulfurized or unsulfurized alkyl or alkenyl naphthenates, metal salts of alkanoic acids, metal salts of an alkyl or alkenyl multiacid, and chemical and physical mixtures thereof.

### Anti-Wear Agents

As their name implies, these agents reduce wear of moving metallic parts. Examples of such agents include, but are not limited to, zinc dithiophosphates, carbamates, esters, and molybdenum complexes.

### Rust Inhibitors (Anti-Rust Agents)

Anti-rust agents reduce corrosion on materials normally subject to corrosion. Examples of anti-rust agents include, but are not limited to, nonionic polyoxyethylene surface active agents such as polyoxyethylene lauryl ether, polyoxyethylene higher alcohol ether, polyoxyethylene nonyl phenyl ether, polyoxyethylene octyl phenyl ether, polyoxyethylene octyl stearyl ether, polyoxyethylene oleyl ether, polyoxyethylene sorbitol monostearate, polyoxyethylene sorbitol mono-oleate, and polyethylene glycol mono-oleate. Other compounds useful as anti-rust agents include, but are not limited to, stearic acid and other fatty acids, dicarboxylic acids, metal soaps, fatty acid amine salts, metal salts of heavy sulfonic acid, partial carboxylic acid ester of polyhydric alcohol, and phosphoric ester.

### Demulsifiers

Demulsifiers are used to aid the separation of an emulsion. Examples of demulsifiers include, but are not limited to, block copolymers of polyethylene glycol and polypropylene glycol, polyethoxylated alkylphenols, polyesteramides, ethoxylated alkylphenol-formaldehyde resins, polyvinylalcohol derivatives and cationic or anionic polyelectrolytes. Mixtures of different types of polymers may also be used.

### Friction Modifiers

Additional friction modifiers may be added to the lubricating oil of the present invention. Examples of friction modifiers include, but are not limited to, fatty alcohols, fatty acids, amines, ethoxylated amines, borated esters, other esters, phosphates, phosphites and phosphonates.

### Multifunctional Additives

Additives with multiple properties such as anti-oxidant and anti-wear properties may also be added to the lubricating oil of the present invention. Examples of multi-functional additives include, but are not limited to, sulfurized oxymolybdenum dithiocarbamate, sulfurized oxymolybdenum organo phosphorodithioate, oxymolybdenum monoglyceride, oxymolybdenum diethylate amide, amine-molybdenum complexes, and sulfur-containing molybdenum complexes.

### Viscosity Index Improvers

Viscosity index improvers, also known as viscosity modifiers, comprise a class of additives that improve the viscosity-temperature characteristics of the lubricating oil, making the oil's viscosity more stable as its temperature changes. Viscosity index improvers may be added to the lubricating oil composition of the present invention. Examples of viscosity index improvers include, but are not limited to, polymethacrylate type polymers, ethylene-propylene copolymers, styrene-isoprene copolymers, alkaline earth metal salts of phosphosulfurized polyisobutylene, hydrated styrene-isoprene copolymers, polyisobutylene, and dispersant type viscosity index improvers.

### Pour Point Depressants

Pour point depressants are polymers that are designed to control wax crystal formation in lubricating oils resulting in lower pour point and improved low temperature flow performance. Examples of pour point depressants include, but are not limited to, polymethyl methacrylate, ethylene vinyl acetate copolymers, polyethylene polymers, and alkylated polystyrenes.

### Foam Inhibitors

Foam inhibitors are used to reduce the foaming tendencies of the lubricating oil. Examples of foam inhibitors include, but are not limited to, alkyl methacrylate polymers, alkylacrylate copolymers, and polymeric organosiloxanes such as dimethylsiloxane polymers.

### Metal Deactivators

Metal deactivators create a film on metal surfaces to prevent the metal from causing the oil to be oxidized. Examples of metal deactivators include, but are not limited to, disalicylidene propylenediamine, triazole derivatives, thiadiazole derivatives, bis-imidazole ethers, and mercaptobenzimidazoles.

### Dispersants

Dispersants diffuse sludge, carbon, soot, oxidation products, and other deposit precursors to prevent them from coagulating resulting in reduced deposit formation, less oil oxidation, and less viscosity increase. Examples of dispersants include, but are not limited to, alkenyl succinimides, alkenyl succinimides modified with other organic compounds, alkenyl succinimides modified by post-treatment with ethylene carbonate or boric acid and polyamide ashless dispersants and the like or mixtures of such dispersants.

### Anti-Oxidants

Anti-oxidants reduce the tendency of mineral oils to deteriorate by inhibiting the formation of oxidation products such as sludge and varnish-like deposits on the metal surfaces. Examples of anti-oxidants useful in the present invention include, but are not limited to, phenol type (phenolic) oxidation inhibitors, such as 4,4′-methylene-bis(2,6-di-tert-butylphenol), 4,4′-bis(2,6-di-tert-butylphenol), 4,4′-bis(2-methyl-6-tert-butylphenol), 2,2′-methylene-bis(4-methyl-6-tert-butylphenol), 4,4′-butylidene-bis(3-methyl-6-tert-butylphenol), 4,4′-isopropylidene-bis(2,6-di-tert-butylphenol), 2,2′-methylene-bis(4-methyl-6-nonylphenol), 2,2′-isobutylidene-bis(4,6-dimethylphenol), 2,2′-5-methylene-bis(4-methyl-6-cyclohexylphenol), 2,6-di-tert-butyl-4-methylphenol, 2,6-di-tert-butyl-4-ethylphenol, 2,4-dimethyl-6-tert-butyl-phenol, 2,6-di-tert-1-dimethylamino-p-cresol, 2,6-di-tert-4-(N,N′-dimethylaminomethylphenol), 4,4′-thiobis(2-methyl-6-tert-butylphenol), 2,2′-thiobis(4-methyl-6-tert-butylphenol), bis(3-methyl-4-hydroxy-5-tert-10-butylbenzyl)-sulfide, and bis(3,5-di-tert-butyl-4-hydroxybenzyl). Diphenylamine-type oxidation inhibitors include, but are not limited to, alkylated diphenylamine, phenyl-alpha-naphthylamine, and alkylated-alpha-naphthylamine Other types of oxidation inhibitors include metal dithiocarbamate (e.g., zinc dithiocarbamate), and methylenebis(dibutyldithiocarbamate).

### Applications

Lubricating oil compositions containing the oil soluble additive compositions disclosed herein are effective as either fluid and grease compositions for modifying the friction properties of the lubricating oil which may, when used as a crankcase lubricant, lead to improved mileage for the vehicle being lubricated with a lubricating oil of this invention.

The lubricating oil compositions of this invention may be used in marine cylinder lubricants as in crosshead diesel engines, crankcase lubricants as in automobiles and railroads, lubricants for heavy machinery such as steel mills and the like, or as greases for bearings and the like. Whether the lubricant is fluid or solid will ordinarily depend on whether a thickening agent is present. Typical thickening agents include polyurea acetates, lithium stearate and the like. The oil soluble additive composition of the invention may also find utility as an anti-oxidant or an anti-wear additive.

### Additional Applications

The oil soluble additive compositions of the invention can be envisioned as hydrotreating catalyst precursors in addition to their use as lubricating oil additives. The oil soluble additive compositions of the invention can act as a catalyst precursor and can be contacted with hydrocarbons and decomposed, in the presence of hydrogen and sulfur or sulfur-bearing compounds to form an active catalyst for hydrotreating a hydrocarbonaceous feedstock. The oil soluble additive compositions of the invention can be heated to the decomposition temperature and decomposed in the presence of hydrogen a hydrocarbon, and sulfur or sulfur-bearing compounds, e.g., at “on-oil” conditions, to form the active catalyst species for hydrotreating.

The nature of the hydrocarbon is not critical, and can generally include any hydrocarbon compound, acyclic or cyclic, saturated or unsaturated, unsubstituted or inertly substituted. The preferred hydrocarbons are those which are liquid at ordinary temperatures, exemplary of which are such straight chain saturated acyclic hydrocarbons as octane, tridecane, eicosane, nonacosane, or the like; straight chain unsaturated acyclic hydrocarbons as 2-hexene, 1,4-hexadiene, and the like; branched chain saturated acyclic hydrocarbons as 3-methylpentane, neopentane, isohexane, 2,7,8-triethyldecane, and the like; branched chain unsaturated acyclic hydrocarbons such as 3,4-dipropyl-1,3-hexadiene-5-yne, 5,5-dimethyl-1-hexene, and the like; cyclic hydrocarbons, saturated or unsaturated, such as cyclohexane, 1,3-cyclohexadiene, and the like; and including such aromatics as cumene, mesitylene, styrene, toluene, o-xylene, or the like. The more preferred hydrocarbons are those derived from petroleum, including especially admixtures of petroleum hydrocarbons characterized as virgin naphthas, cracked naphthas, Fischer-Tropsch naphtha, light cycle oil, medium cycle oil, heavy cycle oil, and the like, typically those containing from about 5 to about 30 carbon atoms, preferably from about 5 to about 20 carbon atoms and boiling within a range of from about 30° C. to about 450° C., preferably from about 150° C. to about 300° C. In decomposing the oil soluble additive compositions of the invention to form a hydrotreating catalyst, a packed bed containing the oil soluble additive compositions of the invention is contacted in a hydrogen atmosphere with both the hydrocarbon and sulfur or sulfur-bearing compound and heated at conditions which decompose said oil soluble additive compositions of the invention.

The sulfur or sulfur-bearing compound is characterized as an organo-sulfur or hydrocarbyl-sulfur compound, which contains one or more carbon-sulfur bonds within the total molecule, and generally includes acyclic or cyclic, saturated or unsaturated, substituted or inertly substituted compounds. Exemplary of acyclic compounds of this character are ethyl sulfide, n-butyl sulfide, n-hexylthiol, diethylsulfone, allyl isothiocyanate, dimethyl disulfide, ethylmethylsulfone, ethylmethylsulfoxide, and the like; cyclic compounds of such character are methylthiophenol, dimethylthiophene, 4-mercaptobenzoic acid, benzenesulfonic acid, 5-formamido-benzothiazole, 1-naphthalenesulfonic acid, dibenzylthiophene, and the like. The sulfur must be present in at least an amount sufficient to provide the desired stoichiometry required for the catalyst, and preferably is employed in excess of this amount. Suitably, both the hydrocarbon and sulfur for the reaction can be supplied by the use of a sulfur-containing hydrocarbon compound, e.g., a heterocyclic sulfur compound, or compounds. Exemplary of heterocyclic sulfur compounds suitable for such purpose are thiophene, dibenzothiophene, tetraphenylthiophene, tetramethyldibenzothiophene, tetrahydrodibenzothiophene, thianthrene, tetramethylthianthrene, and the like. The hydrogen required for forming the catalysts of this invention may be pure hydrogen, an admixture of gases rich in hydrogen or a compound which will generate in situ hydrogen, e.g., a hydrogen-generating gas such as carbon monoxide mixtures with water, or a hydrogen donor solvent.

The following examples are presented to illustrate specific embodiments of this invention and are not to be construed in any way as limiting the scope of the invention

### EXAMPLES

### Comparative Example 1

A 1000 MW polyisobutene succinimide was synthesized, as described in U.S. Published Patent Application No. 2003/0224949 and U.S. Pat. No. 6,962,896, with a final molybdenum content of 4.5 wt % and a TBN of 20 mg of KOH/g of sample.

### Example 2

125 g of molybdated succinimide, which was prepared according to Comparative Example 1, was allowed to heat up to 165° C. After reaching 165° C., 11 g (2 moles of EC per basic nitrogen) of ethylene carbonate (EC) was charged slowly over the duration of 1 hour. After charging the ethylene carbonate, the reaction was allowed to hold at 165° C. for an additional 2 hours until all EC was reacted as monitored by IR spectroscopy with final Mo content=4.1 wt %.

### Example 3

108 g of molybdated succinimide as prepared according to Comparative Example 1, was allowed to heat up to 165° C. After reaching 165° C., 13 g (2 moles of glycerine carbonate per basic nitrogen) of glycerine carbonate (GC) was charged slowly over the duration of 1 hour. After that, the reaction was allowed to hold at 165° C. for an additional 2-2.5 hours until all GC was reacted as monitored by IR spectroscopy with final Mo content=4.0 wt %.

### Example 4

In a 3-neck 500 mL glass reactor equipped with a temperature controller, mechanical stirrer and water cooled condenser, 245.31 g of a succinimide having a TBN of 171 mg of KOH/g of sample, prepared from a hexadecenyl succinic anhydride (HDSA) and diethylenetriamine (DETA) at a molar ratio of DETA to HDSA of 0.9:1, was charged. The reaction mixture was allowed to heat up to 165° C. After reaching 165° C., 65.83 g of ethylene carbonate was charged slowly over the duration of 1 hour. After charging the ethylene carbonate, the reaction was allowed to hold at 165° C. for an additional 2 hours and monitored by IR and the TBN of the resulting solution was measured to be 59 mg of KOH/g of sample.

### Example 5

In a 3-neck 500 mL glass reactor equipped with a temperature controller, mechanical stirrer and water cooled condenser, 95 g of EC treated succinimide as prepared in Example 4 was added with 7 g of MoO₃ (Mo: BN=0.45), 5 gms of water and 60 g of xylene as solvent. The flask was heated for 2-3 hrs at 90° C. until all solid went in. The xylene was stripped off to give 4.61% Mo.

The products from Comparative Example 1 and Examples 2 to 5 were injected in an engine such that the final concentration of molybdenum was at 500 ppm in a partially formulated lubricating oil, containing other additives, such as, but not limited to, at least one dispersant, at least one carboxylate detergent, at least one sulfonate detergent, at least one anti-wear additive, at least one antioxidant, at least one viscosity index improver, at least one foam inhibitor and the remaining being a diluents oil.

The products from Examples 1 to 5 were injected into a running 1994 Mazda KL 2.5 Liter V-6 engine in a partially formulated lubricating oil, containing other additives, such as, but not limited to, at least one dispersant, at least one carboxylate detergent, at least one sulfonate detergent, at least one anti-wear additive, at least one antioxidant, at least one viscosity index improver, at least one foam inhibitor and the remaining comprising diluents oil such that 500 ppm of molybdenum from the additives were added to the engine oil respectively. The engine contained a standard baseline engine oil formulation without a post-treated salt of a molybdenum compound. The brake specific fuel consumption (BSFC) was measured in a stabilized engine before and after the addition of the additive. Data was averaged for 60 minutes at both the start and end of test with the difference expressed as percent change.

### Baseline Formulation

(1) 2 wt % of an oil concentrate of an ethylene carbonate post-treated ashless dispersant
(2) 4.5 wt % of an oil concentrate of a borated dispersant
(3) 2.48 wt % of an oil concentrate alkaline earth metal sulfonate detergent
(4) 1.03 wt % of an oil concentrate zinc dialkyldithiophosphate
(5) 0.9 wt % of an antioxidant
(6) 0.2 wt % of an oil concentrate of a molybdenum succinimide complex
(7) 9.4 wt % of an oil concentrate of a non-dispersant type viscosity index improver
(8) 5 ppm of a foam inhibitor
(9) remainder a Group III lubricating oil

Table 1 shows that the examples of the invention provide lower fuel consumption (BSFC) compared to non-post treated molybdenum compounds.

TABLE 1
Brake Specific Fuel Consumption (BSFC) (%)

| | Description | BSFC (%) |
|---|---|---|
| Comparative | Molybdated product of | 0.11 |
| Example 1 | 1000 MW succinimide | |
| Example 2 | EC treated Comparative Example 1 | −0.68 |
| Example 3 | GC treated Comparative Example 1 | −0.47 |
| Example 4 | EC treated C16-succinimide | −1.21 |
| Example 5 | Molybdated product of Example | −1.72 |
| | EC treated C16-succinimide | |

What is claimed is:

1. An oil soluble additive composition prepared by a process comprising: reacting,
(a) a molybdenum component;
(b) an imide derived from the reaction product of a hydrocarbyl dicarboxylic acid component and a polyamine component wherein the hydrocarbyl dicarboxylic acid component is the reaction product of a dicarboxylic acid component and a hydrocarbyl component; and
(c) a post-treating agent, thereby producing a post-treated molybdated succinimide additive composition.

2. The oil soluble additive composition of claim 1, wherein the molybdenum component is selected from the group consisting of molybdic acid, ammonium molybdate, sodium molybdate, potassium molybdate, metal molybdates, MoOC₁₄, MoO₂Br₂, Mo₂O₃C₁₆, molybdenum trioxide, and mixtures thereof.

3. The oil soluble additive composition of claim 2, wherein the molybdenum component is molybdenum trioxide.

4. The oil soluble additive composition of claim 1, wherein the dicarboxylic acid component is a dicarboxylic acid, salt of a dicarboxylic acid, anhydride of a dicarboxylic acid, ester of a dicarboxylic acid ester, or mixtures thereof.

5. The oil soluble additive composition of claim 1, wherein the charge mole ratio of the hydrocarbyl dicarboxylic acid component to the polyamine component is from about 1:1 to about 1:0.5.

6. The oil soluble additive composition of claim 4, wherein the dicarboxylic acid component is maleic anhydride.

7. The oil soluble additive composition of claim 5, wherein the charge mole ratio of the hydrocarbyl dicarboxylic acid component to the polyamine is from about 1:1 to about 1:0.7.

8. The oil soluble additive composition of claim 1, wherein the polyamine is a polyalkylenepolyamine of the general formula
H₂N(—R—NH)ₙ—H
and wherein R is an alkylene group of 2-3 carbon atoms and n is an integer of from 1 to 11.

9. The oil soluble composition of claim 8, wherein the polyamine is tetraethylenepentamine (TEPA), diethylenetriamine (DETA), ethylenediamine (EDA), or mixtures thereof.

10. The oil soluble additive composition of claim 1 wherein the post-treating agent is a cyclic carbonate.

11. The oil soluble additive composition of claim 10 wherein the cyclic carbonate is ethylene carbonate or glycerine carbonate.

12. A lubricating oil composition comprising:
a. an oil of lubricating viscosity; and
b. the reaction product of
i. a molybdenum component;
ii. an imide derived from the reaction product of a hydrocarbyl dicarboxylic acid component and a polyamine component wherein the hydrocarbyl dicarboxylic acid component is the reaction product of a dicarboxylic acid component and a hydrocarbyl component; and
iii. a post-treating agent, thereby producing a post-treated molybdated succinimide additive composition.

13. The lubricating oil composition of claim 12, wherein the charge mole ratio of the hydrocarbyl dicarboxylic acid component to the polyamine component is from 1:1 to about 1:0.5.

14. The lubricating oil composition of claim 12, wherein the molybdenum content of the lubricating oil composition is between about 50 ppm and 5000 ppm.

15. The lubricating oil composition of claim 12, wherein the oil soluble additive composition content is between 0.05 to 15% by weight.

16. The lubricating oil composition of claim 13, wherein the charge mole ratio of the hydrocarbyl dicarboxylic acid component to the polyamine component is about 1:1 to about 1:0.7.

17. The oil soluble additive composition of claim 12 wherein the post-treating agent is a cyclic carbonate.

18. The lubricating oil composition of claim 17 wherein the cyclic carbonate is ethylene carbonate or glycerine carbonate.

19. A process for preparing an oil soluble additive composition which comprises reacting:
(a) a molybdenum component;
(b) an imide derived from the reaction product of a hydrocarbyl dicarboxylic acid component and a polyamine component wherein the hydrocarbyl dicarboxylic acid component is the reaction product of a dicarboxylic acid component and a hydrocarbyl component; and
(c) a post-treating agent, thereby producing a post-treated molybdated succinimide additive composition.

20. The process of claim 19, wherein the charge mole ratio of the hydrocarbyl dicarboxylic acid component to the polyamine component is from about 1:1 to about 1:0.5.

21. The process of claim 19, wherein the dicarboxylic acid component is a dicarboxylic acid, salt of a dicarboxylic acid, anhydride of a dicarboxylic acid, ester of a dicarboxylic acid ester, or mixtures thereof.

22. The process of claim 21, wherein the dicarboxylic acid component is maleic anhydride.

23. The process of claim 19, wherein said reaction of said molybdenum component and said imide is in the presence of a polar promoter.

24. The process of claim 23, wherein the polar promoter is selected from the group consisting of 1,3-propanediol, 1,4-butanediol, diethylene glycol, butyl cellosolve, propylene glycol, 1,4-butyleneglycol, methyl carbitol, ethanolamine, ammonium hydroxide, alkyl ammonium hydroxide, metal hydroxide, N-methyl-diethanol-amine, dimethyl formamide, N-methyl acetamide, dimethyl acetamide, methanol, ethylene glycol, dimethyl sulfoxide, hexamethyl phosphoramide, tetrahydrofuran, water, inorganic acid, and mixtures thereof.

25. The process of claim 24, wherein the polar promoter is water.

26. The process of claim 19, wherein the molybdenum component is selected from the group consisting of molybdic acid, ammonium molybdate, sodium molybdate, potassium molybdate, metal molybdates, MoOC₁₄, MoO₂Br₂, Mo₂O₃C₁₆, molybdenum trioxide, and mixtures thereof.

27. The process of claim 26, wherein the molybdenum component is molybdenum trioxide.

28. The process of claim 19, wherein the polyamine component comprises a polyalkylenepolyamine represented by the general formula
H₂N(—R—NH)ₙ—H
and wherein R is an alkylene group of 2-3 carbon atoms and n is an integer of from 1 to 11.

29. The process of claim 28, wherein the polyamine component is tetraethylenepentamine (TEPA), diethylenetriamine (DETA), ethylenediamine (EDA), or mixtures thereof.

30. The oil soluble additive composition of claim 19, wherein the post-treating agent is a cyclic carbonate.

31. The process of claim 19, wherein the cyclic carbonate is ethylene carbonate or glycerine carbonate.
